(19) United States
(12) Patent Application Publication
(10) Pub. No.: US 2023/0395839 A1
(43) Pub. Date: Dec. 7, 2023

(54) FOLDING TYPE ALL-SOLID-STATE BATTERY

(71) Applicants: Hyundai Motor Company, Seoul (KR); Kia Corporation, Seoul (KR)

(72) Inventors: Yong Seok Choi, Seoul (KR); Yong Guk Gwon, Hwaseong (KR); Jae Ho Shin, Seoul (KR); Ga Young Choi, Busan (KR); Ju Min Kim, Hwaseong (KR); Min Sun Kim, Goyang (KR)

(21) Appl. No.: 18/080,480

(22) Filed: Dec. 13, 2022

(30) Foreign Application Priority Data
Jun. 7, 2022 (KR) 10-2022-0068636

(51) Int. Cl. H01M 8/2483; H01M 50/548; H01M 8/1041

(52) U.S. Cl. CPC H01M 8/2483; H01M 50/548; H01M 8/1041; H01M 2008/1095

(57) ABSTRACT

An all-solid-state battery, in which a cathode part and an anode part are coupled in a state of being folded in a zigzag form, is disclosed. The cathode part has a shape folded in a zigzag form such that the cathode part is divided into unit areas each corresponding to an area of a unit cathode. The anode part has a shape folded in a zigzag form such that the anode part is divided into unit areas each corresponding to an area of a unit anode. A protrusion portion of the cathode part may be inserted into a recessed portion of the anode part, and a protrusion portion of the anode part may be inserted into a recessed portion of the cathode part.

### CROSS-REFERENCE TO RELATED APPLICATION

This application claims under 35 U.S.C. § 119(a) the benefit of Korean Patent Application No. 10-2022-0068636 filed on Jun. 7, 2022, the entire contents of which are incorporated herein by reference.

### BACKGROUND

### Technical Field

The present disclosure relates to a folding type all-solid-state battery in which a cathode part and an anode part are coupled in a state of being folded in a zigzag form.

### Background

An all-solid-state battery is a three-layer stack including a cathode active material layer bonded to a cathode current collector, an anode active material layer bonded to an anode current collector, and a solid electrolyte layer disposed between the cathode active material layer and an anode active material layer.

Such a unit cell type all-solid-state battery has a drawback in that bonding of each electrode thereof should be performed through punching, and stacking of a plurality of unit cells should be performed and, as such, the manufacturing method thereof is very complex.

### SUMMARY OF THE DISCLOSURE

The present disclosure has been made in an effort to solve the above-described problems associated with the existing technologies, and an object of the present disclosure is to provide a folding type all-solid-state battery having a structure suitable for mass production.

Another object of the present disclosure is to provide a folding type all-solid-state battery having a structure capable of preventing a plurality of electrodes from being short-circuited during stacking thereof.

Objects of the present disclosure are not limited to the above-described objects, and other objects of the present disclosure not yet described will be more clearly understood by those skilled in the art from the following detailed description. In addition, objects of the present disclosure may be accomplished by means defined in the appended claims and combinations thereof.

In one embodiment, the present disclosure provides an all-solid-state battery including a cathode part including a plate-shaped cathode current collector extending in a longitudinal direction, a plurality of unit cathodes provided to be spaced apart from one another in the longitudinal direction of the cathode current collector, and a first electrolyte layer disposed on the cathode collector and the unit cathodes, and an anode part including a plate-shaped anode current collector extending in a longitudinal direction, a plurality of unit anodes provided to be spaced apart from one another in the longitudinal direction of the anode current collector, and a second electrolyte layer disposed on the anode collector and the unit anodes, wherein the cathode part has a shape folded in a zigzag form such that the cathode part is divided into unit areas each corresponding to an area of each of the unit cathodes, and the anode part has a shape folded in a zigzag form such that the anode part is divided into unit areas each corresponding to an area of each of the unit anodes, and wherein a protrusion portion of the cathode part is inserted into a recessed portion of the anode part, and a protrusion portion of the anode part is inserted into a recessed portion of the cathode part.

In some embodiments, the all-solid-state battery includes a reaction area in which the cathode current collector, each unit cathode, the first electrolyte layer, the second electrolyte layer, each unit anode, and the anode current collector are stacked with reference to a cross-section.

In a preferred embodiment, the unit cathodes may be provided on one surface of the cathode current collector.

In another preferred embodiment, each of the unit cathodes may have a thickness of about 50 to about 300 μm.

In still another preferred embodiment, the first electrolyte layer may be coated on the cathode current collector and the unit cathodes in the longitudinal direction of the cathode current collector.

In yet another preferred embodiment, the first electrolyte layer may have a thickness of about 10 to about 500 μm.

In yet another preferred embodiment, the first electrolyte layer may include at least one selected from a group consisting of a sulfide-based solid electrolyte, an oxide-based solid electrolyte, a polymer-based solid electrolyte, and a combination thereof.

In yet another preferred embodiment, the cathode part may satisfy the following Expression 1:

Y₁>10×X₁ [Expression 1]
where, “Y₁” is a distance between the unit cathodes, and “X₁” is a sum of thicknesses of each unit cathode and the first electrolyte layer.

In yet another preferred embodiment, the unit anodes may be provided on one surface of the anode current collector.

In yet another preferred embodiment, each of the unit anodes may have a thickness of about 50 to about 300 μm.

In yet another preferred embodiment, the second electrolyte layer may be coated on the anode current collector and the unit anodes in the longitudinal direction of the anode current collector.

In yet another preferred embodiment, the second electrolyte layer may have a thickness of about 10 to about 500 μm.

In yet another preferred embodiment, the second electrolyte layer may include at least one selected from a group consisting of a sulfide-based solid electrolyte, an oxide-based solid electrolyte, a polymer-based solid electrolyte, and a combination thereof.

In yet another preferred embodiment, the anode part may satisfy the following Expression 2:

Y₂>10×X₂ [Expression 2]
where, “Y₂” is a distance between the unit anodes, and “X₂” is a sum of thicknesses of each unit anode and the second electrolyte layer.

In yet another preferred embodiment, each of the unit anodes may have a length equal to or greater than a length of each of the unit cathodes.

In yet another preferred embodiment, each of the unit anodes may have a greater width than each of the unit cathodes.

In yet another preferred embodiment, the all-solid-state battery may further include a cathode tab connected to a portion of the cathode current collector disposed at an outermost side in a stacking direction.

In yet another preferred embodiment, the all-solid-state battery may further include an anode tab connected to a portion of the anode current collector disposed at an outermost side in a stacking direction.

In some embodiments, the unit cathodes are disposed between the first electrolyte layer and the cathode collector.

In some embodiments, the unit anodes are disposed between the second electrolyte layer and the anode collector.

In another embodiment, vehicles are provided that comprise an apparatus as disclosed herein.

Other embodiments including preferred embodiments of the disclosure are discussed infra.

The above and other features of the disclosure are discussed infra.

### BRIEF DESCRIPTION OF THE DRAWINGS

The above and other features of the present disclosure will now be described in detail with reference to certain exemplary embodiments thereof illustrated in the accompanying drawings which are given hereinbelow by way of illustration only, and thus are not limitative of the present disclosure, and wherein:

FIG. 1 is a sectional view showing an all-solid-state battery according to an exemplary embodiment of the present disclosure;

FIG. 2 is a reference view explaining a cathode part according to an exemplary embodiment of the present disclosure;

FIG. 3 is a reference view explaining an anode part according to an exemplary embodiment of the present disclosure;

FIG. 4 is a plan view showing the cathode part;

FIG. 5 is a sectional view showing the cathode part;

FIG. 6 is a plan view showing the anode part;

FIG. 7 is a sectional view showing the anode part;

FIG. 8 is a sectional view showing one outermost side of the all-solid-state battery according to the exemplary embodiment of the present disclosure;

FIG. 9 is a sectional view showing another outermost side of the all-solid-state battery according to the exemplary embodiment of the present disclosure; and

FIG. 10 is results obtained after measuring charging and discharging capacities of all-solid-state batteries according to Example 1, Example 2 and Comparative Example 2.

It should be understood that the appended drawings are not necessarily to scale, presenting a somewhat simplified representation of various preferred features illustrative of the basic principles of the disclosure. The specific design features of the present disclosure as disclosed herein, including, for example, specific dimensions, orientations, locations, and shapes will be determined in part by the particular intended application and use environment.

In the figures, reference numbers refer to the same or equivalent parts of the present disclosure throughout the several figures of the drawing.

### DETAILED DESCRIPTION

The above and other objectives, features and advantages of the present disclosure will be more clearly understood from the following preferred forms taken in conjunction with the accompanying drawings. However, the present disclosure is not limited to various forms disclosed herein, and may be modified into different forms. These forms are provided to thoroughly explain the disclosure and to sufficiently transfer the spirit of the present disclosure to those skilled in the art.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

Throughout the drawings, the same reference numerals will refer to the same or like elements. For the sake of clarity of the present disclosure, the dimensions of structures are depicted as being larger than the actual sizes thereof. It will be understood that, although terms such as “first”, “second”, etc. may be used herein to describe various elements, these elements are not to be limited by these terms. These terms are only used to distinguish one element from another element. For instance, a “first” element discussed below could be termed a “second” element without departing from the scope of the present disclosure. Similarly, the “second” element could also be termed a “first” element. As used herein, the singular forms are intended to include the plural forms as well, unless the context clearly indicates otherwise.

It will be further understood that the terms “comprise”, “include”, “have”, etc., when used in this specification, specify the presence of stated features, integers, steps, operations, elements, components, or combinations thereof, but do not preclude the presence or addition of one or more other features, integers, steps, operations, elements, components, or combinations thereof. Also, it will be understood that, when an element such as a layer, film, area, or sheet is referred to as being “on” another element, it can be directly on the other element, or intervening elements may be present therebetween. Similarly, when an element such as a layer, film, area, or sheet is referred to as being “under” another element, it can be directly under the other element, or intervening elements may be present therebetween.

Unless otherwise specified, all numbers, values, and/or representations that express the amounts of components, reaction conditions, polymer compositions, and mixtures used herein are to be taken as approximations including various uncertainties affecting measurement that inherently occur in obtaining these values, among others, and thus should be understood to be modified by the term “about” in all cases. Furthermore, when a numerical range is disclosed in this specification, the range is continuous, and includes all values from the minimum value of said range to the maximum value thereof, unless otherwise indicated. Moreover, when such a range pertains to integer values, all integers including the minimum value to the maximum value are included, unless indicated otherwise.

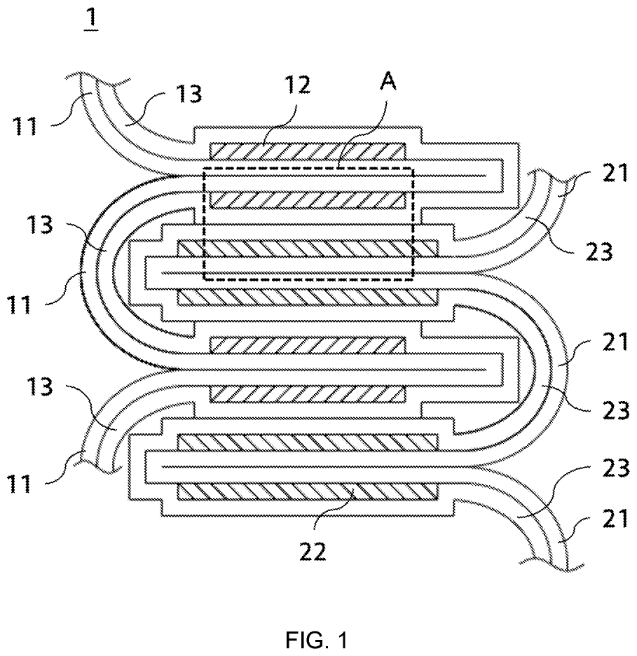

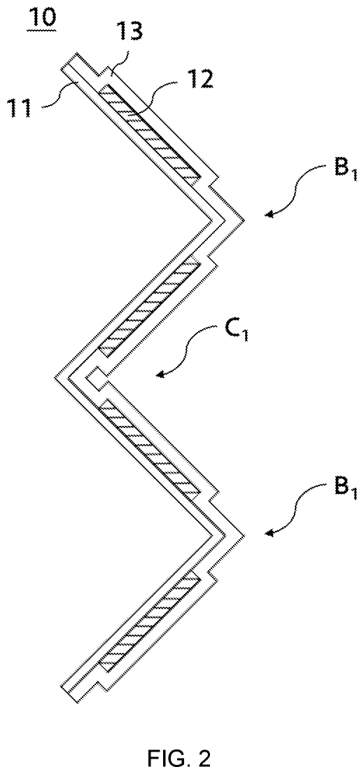

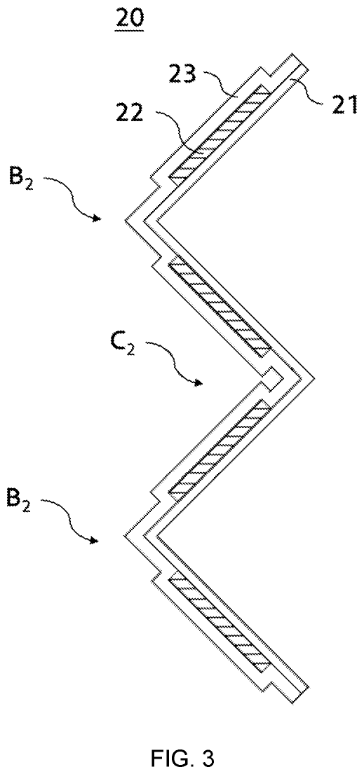

FIG. 1 is a sectional view showing an all-solid-state battery according to an exemplary embodiment of the present disclosure. FIG. 2 is a reference view explaining a cathode part according to an exemplary embodiment of the present disclosure. FIG. 3 is a reference view explaining an anode part according to an exemplary embodiment of the present disclosure. Hereinafter, the all-solid-state battery will be described with reference to FIGS. 1 to 3.

The all-solid-state battery, which is designated by reference numeral “1”, may include a cathode part 10 including a cathode current collector 11, a plurality of unit cathodes 12 disposed to be spaced apart from one another by a uniform distance in a longitudinal direction of the cathode current collector 11, and a first electrolyte layer 13 disposed on the cathode current collector 11 and the unit cathodes 12.

The all-solid-state battery 1 may include an anode part 20 including an anode current collector 21, a plurality of unit anodes 22 disposed to be spaced apart from one another by a uniform distance in a longitudinal direction of the anode current collector 21, and a second electrolyte layer 23 disposed on the anode current collector 21 and the unit anodes 22.

Referring to FIG. 2, the cathode part 10 may have a folded shape in which the cathode part 10 is folded in a zigzag form such that the cathode part 10 is divided into portions each having a unit area corresponding to the area of each unit cathode 12. Here, the unit area corresponding to the area of the unit cathode 12 means an area on which the unit cathode 12 can be sufficiently formed, and is not limited to a specific value. In accordance with the above-described structure, the cathode part 10 may include a protrusion portion B₁ and a recessed portion C₁.

Referring to FIG. 3, the anode part 20 may have a folded shape in which the anode part 20 is folded in a zigzag form such that the anode part 20 is divided into portions each having a unit area corresponding to the area of each unit anode 22. Here, the unit area corresponding to the area of the unit anode 22 means an area on which the unit anode 22 can be sufficiently formed, and is not limited to a specific value. In accordance with the above-described structure, the anode part 20 may include a protrusion portion B₂ and a recessed portion C₂.

The all-solid-state battery 10 may be configured such that the protrusion portion B₁ of the cathode 10 is inserted into the recessed portion C₂ of the anode 20, and the protrusion portion of B₂ of the anode 20 is inserted into the recessed portion C₁ of the cathode 10. Accordingly, the all-solid-state battery 10 may include a reaction area A in which the cathode current collector 11, the unit cathode 12, the first electrolyte layer 13, the second electrolyte layer 23, the unit anode 22, and the anode current collector 21 are stacked with reference to a cross-section as shown in FIG. 1. Here, the reaction area A is an area in which the unit cathode 12 and the unit anode 22 face each other with reference to the first electrolyte layer 13 and the second electrolyte layer 23, and may mean an area in which oxidation and reduction occurs.

Although FIG. 1 shows an empty space between the cathode part 10 and the anode part 20, this illustration is only for better understanding of assembly relationship between both parts 10 and 20. In a practical case, empty spaces of the all-solid-state battery may be filled with the first electrolyte layer 13 and the second electrolyte layer 23 through pressing or the like.

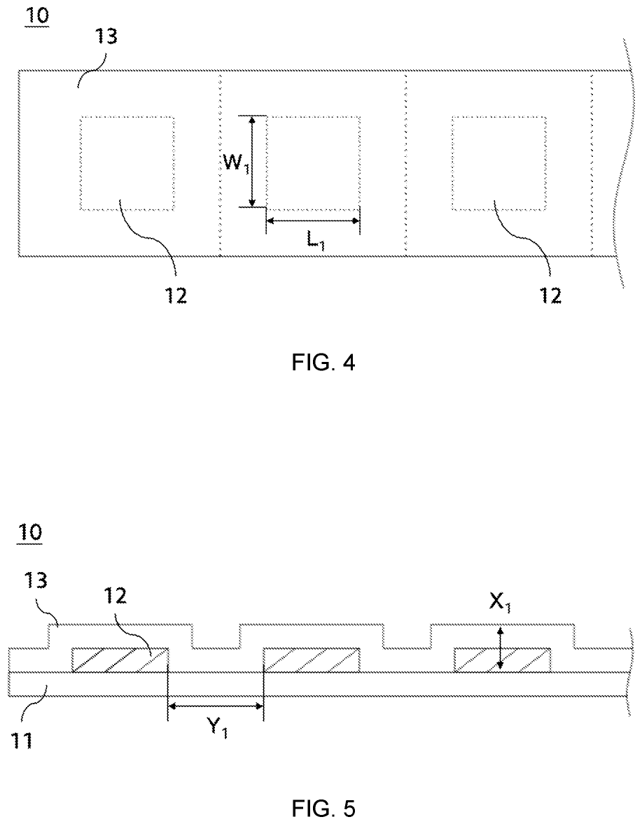

FIG. 4 is a plan view showing the cathode part 10. FIG. 5 is a sectional view showing the cathode part 10. FIGS. 4 and 5 show the cathode part 10 in a state before folding. This illustration is only for convenience of description, and those skilled in the art may clearly understand relationships among configurations in the all-solid-state battery 1 upon configuring the all-solid-state battery 1. In addition, the dimension scales of constituent elements shown in the drawings may be different from actual dimension scales. That is, the dimension scales of constituent elements shown in the drawings are the same as those described in the detailed description and, as such, should not be interpreted to be the same as those shown in the drawings.

The cathode current collector 11 may have the form of a plate extending in a longitudinal direction.

The cathode current collector 11 may include a material having electrical conductivity. For example, the cathode current collector 11 may include an aluminum foil. In addition, the cathode current collector 11 may be coated with carbon at a surface thereof. In this case, carbon functions to enhance electrical conductivity.

The thickness of the cathode current collector 11 is not limited to a specific value, and may be, for example, about 5 to about 20 μm.

The unit cathode 12 has a predetermined length Li and a predetermined width Wi, and may be provided in plural such that a plurality of unit cathodes 12 is spaced apart from one another in a longitudinal direction of the cathode current collector 11.

The unit cathode 12 may include a cathode active material, a solid electrolyte, a conductive material, a binder, etc.

The cathode active material may be an oxide active material or a sulfide active material.

The oxide active material may be a rock salt layer type active material such as LiCoO₂, LiMnO₂, LiNiO₂, LiVO₂, Li₁₊ₓNi_{1/3}Co_{1/3}Mn_{1/3}O₂ or the like, a spinel type active material such as LiMn₂O₄, Li(Ni_{0.5}Mn_{1.5})O₄ or the like, an inverse spinel type active material such as LiNiVO₄, LiCoVO₄ or the like, an olivine type active material such as LiFePO₄, LiMnPO₄, LiCoPO₄, LiNiPO₄ or the like, a silicon-containing active material such as Li₂FeSiO₄, Li₂MnSiO₄ or the like, a rock salt layer type active material, a part of a transition metal of which is substituted by a different kind of metal, such as LiNi_{0.8}Co_{(0.2-x)}AlₓO₂ (0<x<0.2), a spinel type active material, a part of a transition metal of which is substituted by a different kind of metal, such as Li₁₊ₓMn_{2-x-y}M_{y}O₄ (M being at least one selected from the group consisting of Al, Mg, Co Fe, Ni and Zn, and 0<x+y<2), and lithium titanate such as Li₄Ti₅O₁₂ or the like

The sulfide active material may be copper Chevrel, iron sulfide, cobalt sulfide, nickel sulfide, or the like.

A loading amount of the cathode active material is not limited to a specific value, and may be 10 to 35 mg/cm².

The solid electrolyte may be an oxide solid electrolyte or a sulfide solid electrolyte. Of course, it may be preferred that a sulfide-based solid electrolyte having high lithium ion conductivity be used. Although the sulfide-based solid electrolyte is not limited to a specific one, the sulfide-based solid electrolyte may be Li₂S—P₂S₅, Li₂S—P₂S₅—LiI, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—S₂S₃—LiI, Li₂S—SiS₂—P₂S₅—LiI, Li₂S—B₂S₃, Li₂S—P₂S₅—ZₘSₙ (m and n being positive numbers, and Z being one of Ge, Zn and Ga), Li₂S—GeS₂, Li₂S—SiS₂—Li₃PO₄, Li₂S—SiS₂-LiₓMO_{y} (x and y being positive numbers, and M being one of P, Si, Ge, B, Al, Ga and In), Li₁₀GeP₂S₁₂, or the like.

The conductive material may be carbon black, conductive graphite, ethylene black, graphene, or the like.

The binder may be butadiene rubber (BR), nitrile butadiene rubber (NBR), hydrogenated nitrile butadiene rubber (HNBR), polyvinylidene difluoride (PVDF), polytetrafluoroethylene (P E), carboxymethylcellulose (CMC), or the like.

The unit cathode 12 may have a thickness of about 50 to about 300 μm. When the thickness of the unit cathode 12 is less than about 50 μm, the capacity of the all-solid-state battery 1 may be reduced. When the thickness of the unit cathode 12 is more than about 300 μm, it may be difficult to stably form a stack structure.

The mixture density of the unit cathode 12 is not limited to a specific value, and may be, for example, 0.5 to 5.0 g/cc.

A method of forming the unit cathode 12 is not limited to a specific method. The unit cathode 12 may be formed by preparing a slurry including the cathode active material, the solid electrolyte, the conductive material, the binder, etc., and then directly coating the cathode current collector 11 with the slurry. Alternatively, the unit cathode 12 may be formed by coating the slurry on a releasable sheet, and may then be transferred onto the cathode current collector 11. Otherwise, the unit cathode 12 may be formed by charging, into a mold, the cathode active material, the solid electrolyte, the conductive material, the binder, etc. in a powder state, and then pressing the mold, and the formed unit cathode 12 may then be transferred onto the cathode current collector 11.

The first electrolyte layer 13 may be coated on the cathode current collector 11 and the unit cathode 12 in the longitudinal direction of the cathode current collector 11. In particular, it may be preferred, in terms of prevention of short circuit, that the first electrolyte layer 13 be coated to completely cover a surface and a side surface of the unit cathode 12.

The first electrolyte layer 13 may include at least one selected from the group consisting of a sulfide-based solid electrolyte, an oxide-based solid electrolyte, a polymer-based solid electrolyte, and a combination thereof.

The sulfide-based solid electrolyte may be Li₂S—P₂S₅, Li₂S—P₂S₅—LiI, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (m and n being positive numbers, and Z being one of Ge, Zn and Ga), Li₂S—GeS₂, Li₂S—SiS₂—Li₃PO₄, Li₂S—SiS₂-LiₓMO_{y} (x and y being positive numbers, and M being one of P, Si, Ge, B, Al, Ga and In), Li₁₀GeP₂S₁₂, or the like.

The oxide-based solid electrolyte may include perovskite type Li₃ₓLa_{2/3-x}TiO₃ (LLTO), phosphate-based NASICON type Li₁₊ₓAlₓTi₂₋ₓ(PO₄)₃ (LATP), or the like.

The polymer-based solid electrolyte may include a gel polymer electrolyte, a solid polymer electrolyte, or the like, and may include, for example, polyethylene oxide (PEO).

The first electrolyte layer 13 may have a thickness of about 10 to about 500 μm. When the thickness of the first electrolyte layer 13 is less than about 10 μm, it may be difficult to prevent contact between the unit cathode 12 and the unit anode 22. When the thickness of the first electrolyte layer 13 is more than about 500 μm, it may be difficult to stably form a stack structure.

The cathode part 10 may satisfy the following Expression 1:

Y₁>10×X₁. [Expression 1]

In Expression 1, “Y₁” may be a distance between the unit cathodes 12, and “X₁” may be a sum of thicknesses of the unit cathode 12 and the first electrolyte layer 13. The sum of thicknesses of the unit cathode 12 and the first electrolyte layer 13 may mean a sum of thicknesses of both configurations in the reaction area as described above.

When the distance Y₁ between the unit cathodes 12 is short, as compared to the thickness X₁ of the unit cathode 12 and the first electrolyte layer 13, the above-described unit area may be too short to stably form the stack structure and, as such, there may be a problem of occurrence of short circuit of the battery, etc.

Meanwhile, although an upper limit of the distance between the unit cathodes 12 is not limited to a specific value, the upper limit of the distance between the unit cathodes 12 may be 50×X₁, 30×X₁, or 20×X₁. When the distance between the unit cathodes 12 is excessively great, an area where no reaction occurs is excessively wide and, as such, it may be difficult to form a stack structure, and productivity may also be degraded.

The distance between the unit cathodes 12 may be appropriately adjusted within a range satisfying the above Expression 1. That is, the distances among the plurality of unit cathodes 12 may be equal or may be different within the range satisfying the above Expression 1. For example, the unit cathodes 12 may be formed such that the distance between the unit cathodes 12 constituting the protrusion portion B₁ is narrow, and the distance between the unit cathodes 12 constituting the recessed portion C₁ is wide.

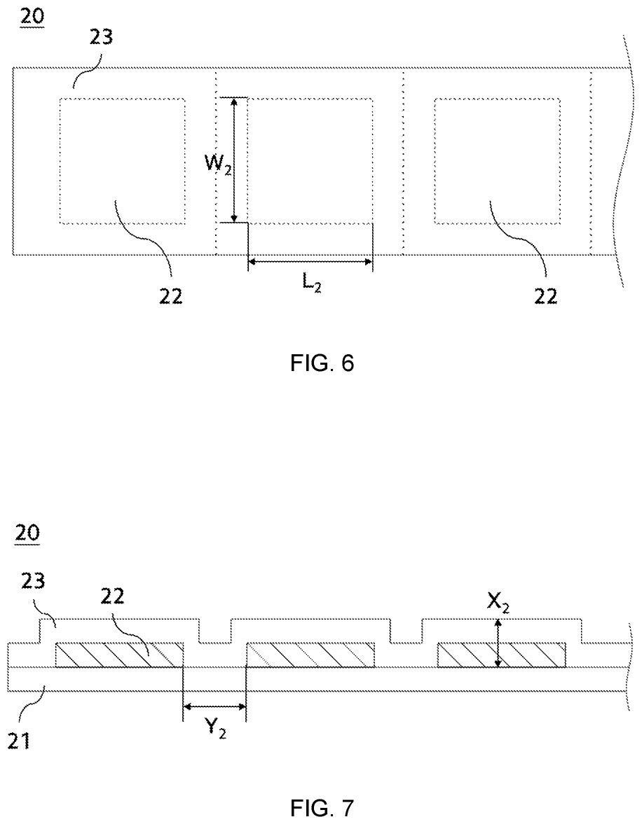

FIG. 6 is a plan view showing the anode part 20. FIG. 7 is a sectional view showing the anode part 20. FIGS. 6 and 7 show the anode part 20 in a state before folding. This illustration is only for convenience of description, and those skilled in the art may clearly understand relationships of configurations in the all-solid-state battery 1 upon configuring the all-solid-state battery 1. In addition, the dimension scales of constituent elements shown in the drawings may be different from actual dimension scales. That is, the dimension scales of constituent elements shown in the drawings are the same as those described in the detailed description and, as such, should not be interpreted to be the same as those shown in the drawings.

The anode current collector 21 may have the form of a plate extending in a longitudinal direction.

The anode current collector 21 may include a material having electrical conductivity. For example, the anode current collector 21 may include at least one selected from the group consisting of copper (Cu), nickel (Ni), stainless steel (SUS), and a combination thereof.

The anode current collector 21 may be a high-density metal thin film having porosity of less than about 1%.

The thickness of the anode current collector 21 is not limited to a specific value, and may be, for example, about 4 to about 20 μm.

The unit anode 22 has a predetermined length L₂ and a predetermined width W₂, and may be provided in plural such that a plurality of unit anodes 22 is spaced apart from one another in a longitudinal direction of the anode current collector 21.

In accordance with a first embodiment of the present disclosure, the unit anode 22 may be a complex anode including an anode active material and a solid electrolyte.

The anode active material may be limited to a specific material, and may be a carbon active material or a metal active material.

The carbon active material may be graphite such as mesocarbon microbeads (MCMBs), highly-oriented pyrolytic graphite (HOPG) or the like, or amorphous carbon such as hard carbon, soft carbon or the like.

The metal active material may be In, Al, Si, Sn, an alloy including at least one thereof, or the like.

The solid electrolyte may include an oxide solid electrolyte or a sulfide solid electrolyte. Of course, it may be preferred that a sulfide-based solid electrolyte having high lithium ion conductivity be used. The sulfide-based solid electrolyte may be Li₂S—P₂S₅, Li₂S—P₂S₅—LiI, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (m and n being positive numbers, and Z being one of Ge, Zn and Ga), Li₂S—GeS₂, Li₂S—SiS₂—Li₃PO₄, Li₂S—SiS₂-LiₓMO_{y} (x and y being positive numbers, and M being one of P, Si, Ge, B, Al, Ga and In), Li₁₀GeP₂S₁₂, or the like.

In accordance with a second embodiment of the present disclosure, the unit anode 22 may include lithium metal or a lithium metal alloy.

The lithium metal alloy may include lithium or an alloy of a metal or a semi-metal alloyable with lithium. The metal or semi-metal alloyable with lithium may include Si, Sn, Al Ge, Pb, Bi, Sb, or the like.

In accordance with a third embodiment of the present disclosure, the unit anode 22 may not include an anode active material and a configuration having substantially the same function as the anode active material. Lithium ions, which migrate from the unit cathode 12 upon charging the all-solid-state battery, may be precipitated and stored in the form of lithium metal between the unit anode 22 and the anode current collector 21.

The unit anode 22 may include amorphous carbon and a metal capable of forming an alloy together with lithium.

The amorphous carbon may include at least one selected from the group consisting of furnace black, acetylene black, Ketjen black, graphene, and a combination thereof.

The metal may include at least one selected from the group consisting of gold (Au), platinum (Pt), palladium (Pd), silicon (Si), silver (Ag), aluminum (Al), bismuth (Bi), tin (Sn), zinc (Zn), and a combination thereof.

The unit anode 22 may have a thickness of about 50 to about 300 μm. When the thickness of the unit anode 22 is less than about 50 μm, the capacity of the all-solid-state battery 1 may be reduced. When the thickness of the unit anode 22 is more than about 300 μm, it may be difficult to stably form a stack structure.

The mixture density of the unit anode 22 is not limited to a specific value, and may be, for example, 0.1 to 3.5 g/cc.

A method of forming the unit anode 22 is not limited to a specific method. The unit anode 22 may be formed by preparing a slurry including the anode active material, the solid electrolyte, etc., and then directly coating the anode current collector 21 with the slurry. Alternatively, the unit anode 22 may be formed by coating the slurry on a releasable sheet, and may then be transferred onto the anode current collector 21. Otherwise, the unit anode 22 may be formed by charging, into a mold, the anode active material, the solid electrolyte, etc. in a powder state, and then pressing the mold, and the formed unit anode 22 may then be transferred onto the anode current collector 21. Otherwise, the unit anode 22 may be formed by directly attaching lithium metal or a lithium alloy to the anode current collector 21.

The second electrolyte layer 23 may be coated on the anode current collector 21 and the unit anode 22 in the longitudinal direction of the anode current collector 21. In particular, it may be preferred, in terms of prevention of short circuit, that the second electrolyte layer 23 be coated to completely cover a surface and a side surface of the unit anode 22.

The second electrolyte layer 23 may include at least one selected from the group consisting of a sulfide-based solid electrolyte, an oxide-based solid electrolyte, a polymer-based solid electrolyte, and a combination thereof.

The sulfide-based solid electrolyte may be Li₂S—P₂S₅, Li₂S—P₂S₅—LiI, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (m and n being positive numbers, and Z being one of Ge, Zn and Ga), Li₂S—GeS₂, Li₂S—SiS₂—Li₃PO₄, Li₂S—SiS₂-LiₓMO_{y} (x and y being positive numbers, and M being one of P, Si, Ge, B, Al, Ga and In), Li₁₀GeP₂S₁₂, or the like.

The oxide-based solid electrolyte may include perovskite type Li₃ₓLa_{2/3-x}TiO₃ (LLTO), phosphate-based NASICON type Li₁₊ₓAlₓTi₂₋ₓ(PO₄)₃ (LATP), or the like.

The polymer-based solid electrolyte may include a gel polymer electrolyte, a solid polymer electrolyte, or the like, and may include, for example, polyethylene oxide (PEO).

The second electrolyte layer 23 may have a thickness of about 10 to about 500 μm. When the thickness of the second electrolyte layer 23 is less than about 10 μm, it may be difficult to prevent contact between the unit cathode 12 and the unit anode 22. When the thickness of the second electrolyte layer 23 is more than about 500 μm, it may be difficult to stably form a stack structure.

The anode part 20 may satisfy the following Expression 2:

Y₂>10×X₂. [Expression 2]

In Expression 2, “Y₂” may be a distance between the unit anodes 22, and “X₂” may be a sum of thicknesses of the unit anode 22 and the second electrolyte layer 23. The sum of thicknesses of the unit anode 22 and the second electrolyte layer 23 may mean a sum of thicknesses of both configurations in the reaction area as described above.

When the distance Y₂ between the unit anodes 12 is short, as compared to the thickness X₂ of the unit anode 22 and the second electrolyte layer 23, the above-described unit area may be too short to stably form the stack structure and, as such, there may be a problem of occurrence of short circuit of the battery, etc.

Meanwhile, although an upper limit of the distance between the unit anodes 22 is not limited to a specific value, the upper limit of the distance between the unit anodes 22 may be 50×X₂, 30×X₂, or 20×X₂. When the distance between the unit anodes 22 is excessively great, an area where no reaction occurs is excessively wide and, as such, it may be difficult to form a stack structure, and productivity may also be degraded.

The distance between the unit anodes 22 may be appropriately adjusted within a range satisfying the above Expression 2. That is, the distances among the plurality of unit anodes 22 may be equal or may be different within the range satisfying the above Expression 2. For example, the unit anodes 22 may be formed such that the distance between the unit anodes 22 constituting the protrusion portion B₂ is narrow, and the distance between the unit anodes 22 constituting the recessed portion C₂ is wide.

Meanwhile, in the all-solid-state battery 1 having the stack structure as shown in FIG. 1 according to the exemplary embodiment of the present disclosure, the length L₂ of the unit anode 22 may be equal to or greater than the length Li of the unit cathode 12. In addition, in the all-solid-state battery 1, the width W₂ of the unit anode 22 may be greater than the width Wi of the unit cathode 12. When the unit cathode 12 and the unit anode 22 are equal in length and width, short circuit may occur at edges of both electrodes. Therefore, it may be preferred that the unit anode 22 be formed to be greater than the unit cathode 12.

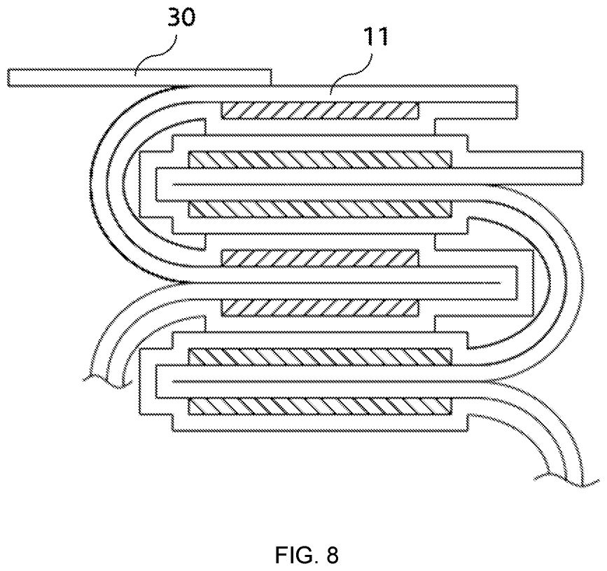

FIG. 8 is a sectional view showing one outermost side of the all-solid-state battery according to the exemplary embodiment of the present disclosure. The all-solid-state battery may further include a cathode tab 30 connected to a cathode current collector 11 disposed at an outermost side of the all-solid-state battery in a stacking direction.

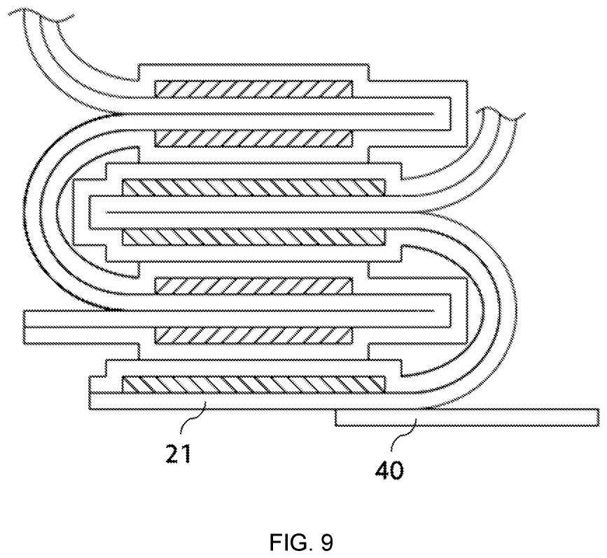

FIG. 9 is a sectional view showing another outermost side of the all-solid-state battery according to the exemplary embodiment of the present disclosure. Referring to FIG. 9, the all-solid-state battery may further include an anode tab 40 connected to an anode current collector 21 disposed at an outermost side of the all-solid-state battery in a stacking direction.

A manufacturing method of an all-solid-state battery according to an exemplary embodiment of the present disclosure is not limited to a specific manufacturing method. For example, the manufacturing method may include obtaining a cathode part 10 by forming a plurality of unit cathodes 12 on a cathode current collector 11, and forming a first electrolyte layer 13 on the plurality of unit cathodes 12, obtaining an anode part 20 by forming a plurality of unit anodes 22 on an anode current collector 21, and forming a second electrolyte layer 23 on the plurality of unit anodes 22, folding the cathode part 10 in a manner as shown in FIG. 2, folding the anode part 20 in a manner as shown in FIG. 3, assembling the cathode part 10 and the anode part 20 such that a protrusion portion B₁ of the cathode part 10 is inserted into a recessed portion C₂ of the anode portion 20, and a protrusion portion B₂ of the anode part 20 is inserted into a recessed portion C₁ of the cathode portion 10, and pressing the resultant structure.

Hereinafter, another embodiment of the present disclosure will be described in more detail through examples. The following examples are only illustrative for better understanding of the present disclosure and, as such, the scope of the present disclosure is not limited thereto.

### Example 1, Example 2, Comparative Example 1, and Comparative Example 2

Unit cathodes having a thickness of about 150 μm were formed on a cathode current collector. A first electrolyte layer including a sulfide-based solid electrolyte was formed to a thickness of about 150 μm on the unit cathodes, thereby obtaining a cathode part.

A coating layer including amorphous carbon and a metal according to the above-described third embodiment was formed on an anode current collector. A second electrolyte layer including a sulfide-based solid electrolyte was formed on unit anodes, thereby obtaining an anode part.

The width and length of the unit anode is greater than those of the unit cathode.

TABLE 1

| | Comp. | | Comp. | | | | | |
|---|---|---|---|---|---|---|---|---|
| Items | Example 1 | | Example 2 | | Example 1 | | Example 2 | |
| X₁ | 300 | μm | 300 | μm | 300 | μm | 300 | μm |
| Y₁ | 2 | mm | 3 | mm | 4 | mm | 5 | mm |
| Relation | Y₁ = | | Y₁ = | | Y₁ = | | Y₁ = | |
| between X₁ and Y₁ | 6.7 × X₁ | | 10 × X₁ | | 13.3 × X₁ | | 16.7 × X₁ | |
| X₂ | 10 | μm | 10 | μm | 10 | μm | 10 | μm |
| Y₂ | 1 | mm | 2 | mm | 3 | mm | 4 | mm |

| | | | | |
|---|---|---|---|---|
| Relation | Y₂ = | Y₂ = | Y₂ = | Y₂ = |
| between X₂ and Y₂ | 100 × X₂ | 200 × X₂ | 300 × X₂ | 400 × X₂ |
| Cell Driving | Occurrence | Degradation | Normal | Normal |
| State | of Short | of Capacity | Behavior | Behavior |
| (Capacity) | Circuit | (136 | (174 | (176 |
| | | mAh/g) | mAh/g) | mAh/g) |

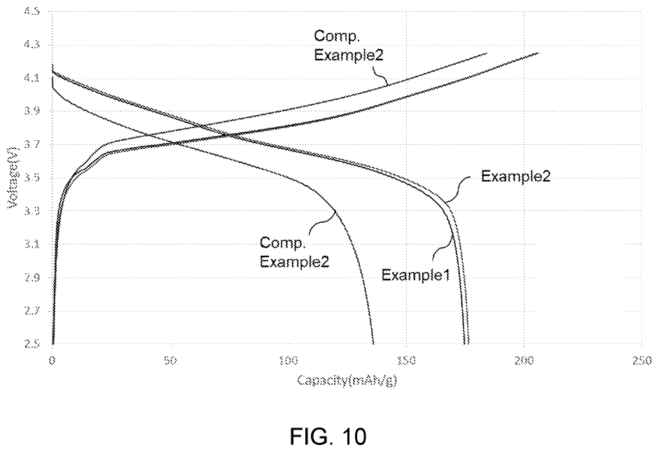

FIG. 10 is results obtained after measuring charging and discharging capacities of all-solid-state batteries according to Example 1, Example 2 and Comparative Example 2.

Referring to Table 1 and FIG. 10, short circuit occurred in Comparative Example 1, and capacity was degraded in Comparative Example 2. On the other hand, in Example 1 and Example 2, it was confirmed that normal driving is possible when a battery has a stack structure as shown in FIG. 1.

Although experimental examples and examples of the present disclosure have been described in detail, the scope of the present disclosure is not limited thereto. Various modifications and improvements capable of being devised by those skilled in the art using the basic concept of the present disclosure defined in the following claims also fall within the scope of the present disclosure.

As apparent from the above description, in accordance with the exemplary embodiments of the present disclosure, it may be possible to obtain a folding type all-solid-state battery having a structure suitable for mass production.

In accordance with the exemplary embodiments of the present disclosure, it may be possible to obtain a folding type all-solid-state battery having a structure capable of preventing a plurality of electrodes from being short-circuited during stacking thereof.

Effects attainable in the present disclosure are not limited to the above-described effects, and other effects of the present disclosure not yet described will be more clearly understood by those skilled in the art from the appended claims.

The disclosure has been described in detail with reference to preferred embodiments thereof. However, it will be appreciated by those skilled in the art that changes may be made in these embodiments without departing from the principles and spirit of the disclosure, the scope of which is defined in the appended claims and their equivalents.

What is claimed is:

1. An all-solid-state battery comprising:
a cathode part comprising:
a cathode current collector having a shape of a plate and extending in a longitudinal direction,
a plurality of unit cathodes provided to be spaced apart from one another in the longitudinal direction of the cathode current collector, and
a first electrolyte layer disposed on the cathode collector and the unit cathodes; and
an anode part comprising:
an anode current collector having a shape of a plate and extending in a longitudinal direction,
a plurality of unit anodes provided to be spaced apart from one another in the longitudinal direction of the anode current collector, and
a second electrolyte layer disposed on the anode collector and the unit anodes,
wherein the cathode part has a shape folded in a zigzag form such that the cathode part is divided into unit areas each corresponding to an area of each of the unit cathodes, and the anode part has a shape folded in a zigzag form such that the anode part is divided into unit areas each corresponding to an area of each of the unit anodes, and
wherein a protrusion portion of the cathode part is inserted into a recessed portion of the anode part, and a protrusion portion of the anode part is inserted into a recessed portion of the cathode part.

2. The all-solid-state battery according to claim 1, wherein the unit cathodes are provided on one surface of the cathode current collector.

3. The all-solid-state battery according to claim 1, wherein each of the unit cathodes has a thickness of about 50 to about 300 μm.

4. The all-solid-state battery according to claim 1, wherein the first electrolyte layer is disposed on the cathode current collector and the unit cathodes in the longitudinal direction of the cathode current collector.

5. The all-solid-state battery according to claim 1, wherein the first electrolyte layer has a thickness of about 10 to about 500 μm.

6. The all-solid-state battery according to claim 1, wherein the first electrolyte layer comprises at least one of a sulfide-based solid electrolyte, an oxide-based solid electrolyte, a polymer-based solid electrolyte or any combination thereof.

7. The all-solid-state battery according to claim 1, wherein the cathode part satisfies the following Expression 1:
Y₁>10×X₁ [Expression 1]
wherein, Y₁ is a distance between the unit cathodes, and X₁ is a sum of thicknesses of each unit cathode and the first electrolyte layer.

8. The all-solid-state battery according to claim 1, wherein the unit anodes are provided on one surface of the anode current collector.

9. The all-solid-state battery according to claim 1, wherein each of the unit anodes has a thickness of about 50 to about 300 μm.

10. The all-solid-state battery according to claim 1, wherein the second electrolyte layer is disposed on the anode current collector and the unit anodes in the longitudinal direction of the anode current collector.

11. The all-solid-state battery according to claim 1, wherein the second electrolyte layer has a thickness of about 10 to about 500 μm.

12. The all-solid-state battery according to claim 1, wherein the second electrolyte layer comprises at least one of a sulfide-based solid electrolyte, an oxide-based solid electrolyte, a polymer-based solid electrolyte or any combination thereof.

13. The all-solid-state battery according to claim 1, wherein the anode part satisfies the following Expression 2:
Y₂>10×X₂ [Expression 2]
wherein, Y₂ is a distance between the unit anodes, and X₂ is a sum of thicknesses of each unit anode and the second electrolyte layer.

14. The all-solid-state battery according to claim 1, wherein each of the unit anodes has a length equal to or greater than a length of each of the unit cathodes.

15. The all-solid-state battery according to claim 1, wherein each of the unit anodes has a greater width than each of the unit cathodes.

16. The all-solid-state battery according to claim 1, wherein the all-solid-state battery further comprises:
a cathode tab connected to a portion of the cathode current collector which is disposed at an outermost side in a stacking direction.

17. The all-solid-state battery according to claim 1, wherein the all-solid-state battery further comprises:
an anode tab connected to a portion of the anode current collector which is disposed at an outermost side in a stacking direction.

18. The all-solid-state battery according to claim 1, wherein the all-solid-state battery comprises a reaction area in which the cathode current collector, one of unit cathodes, the first electrolyte layer, the second electrolyte layer, one of unit anodes, and the anode current collector are stacked with reference to a cross-section.

19. The all-solid-state battery according to claim 1, wherein the unit cathodes are disposed between the first electrolyte layer and the cathode collector.

20. The all-solid-state battery according to claim 1, wherein the unit anodes are disposed between the second electrolyte layer and the anode collector.
